(19) United States
(12) Patent Application Publication
(10) Pub. No.: US 2021/0381463 A1
(43) Pub. Date: Dec. 9, 2021

(54) FUEL PRESSURE CONTROL DEVICE FOR INTERNAL COMBUSTION ENGINE

(71) Applicant: HONDA MOTOR CO., LTD., Tokyo (JP)

(72) Inventors: Masahiro YAMADA, Saitama-ken (JP); Kazuhiko IMAMURA, Saitama-ken (JP); Toshiyuki KABASHIMA, Saitama-ken (JP); Kenji AKIMOTO, Saitama-ken (JP)

(21) Appl. No.: 17/337,871

(22) Filed: Jun. 3, 2021

(30) Foreign Application Priority Data
Jun. 8, 2020 (JP) 2020-099158

(51) Int. Cl. F02D 41/38

(52) U.S. Cl. CPC F02D 41/3836; F02D 2200/101; F02D 2200/0602; F02D 2200/0606

(57) ABSTRACT

In a fuel pressure control device for an internal combustion engine of the invention, a first map (FIG. 4A) for defining a first target fuel pressure for normal time and a second map (FIG. 5A) for defining a second target fuel pressure for suppressing noise and vibration smaller than the first target fuel pressure are stored. When an acquired fuel temperature is higher than a predetermined temperature, the first target fuel pressure defined in the first map is set as a target fuel pressure (steps 1 to 3), and when the fuel temperature is equal to or lower than the predetermined temperature, the second target fuel pressure defined in the second map is set as the target fuel pressure (steps 1, 5, and 6). The fuel pressure is controlled based on the set target fuel pressure (step 7).

### BACKGROUND

### Technical Field

The present invention relates to a fuel pressure control device for an internal combustion engine which controls a fuel pressure which is a pressure of fuel which is supplied to a fuel injection valve by a pressure applied from a fuel pump.

### Related Art

As a conventional fuel pressure control device for an internal combustion engine, a fuel pressure control device disclosed in, for example, JP 63-16161 A is known. In JP 63-16161 A, the internal combustion engine uses a liquefied gas fuel, and a fuel injection valve is configured to inject the fuel into an intake passage. Further, a fuel pump is provided in a fuel supply passage extending from a fuel tank to the fuel injection valve, a pressure regulator is provided in a fuel return passage extending from the fuel injection valve to the fuel tank, and the liquefied gas fuel is pressurized by the fuel pump. When the pressure thereof is adjusted by the pressure regulator, the pressure (fuel pressure) of the liquefied gas fuel is controlled.

In this fuel pressure control device, the fuel pressure is controlled for the purpose of compensating for a substantial decrease in fuel injection amount caused when the fuel is heated to a high temperature to be evaporated in the vicinity of the fuel supply passage or the fuel injection valve after the stop of the internal combustion engine or the like. Specifically, the temperature of the fuel is detected by a temperature sensor, and the fuel pressure is controlled to be changed in proportion to the detected fuel temperature in a stepless or multi-step manner. Accordingly, the fuel pressure is increased as the fuel temperature increases, and the substantial decrease in fuel injection amount is compensated, thereby ensuring a proper fuel injection amount without correcting a fuel injection time.

### SUMMARY

It is confirmed that particularly in a case where the fuel pressure is high, the noise and vibration characteristics of the fuel pump vary depending on the temperature of the fuel, the vibration of the fuel pump increases as the fuel temperature decreases, and the noise increases accordingly. On the other hand, in the conventional fuel pressure control device described above, the fuel pressure is merely increased in proportion to the fuel temperature in order to compensate for the evaporated amount of the fuel in a high temperature state, and thus the noise and vibration of the fuel pump cannot be suppressed satisfactorily.

The present invention was made to solve the above problems, and an object thereof is to provide a fuel pressure control device for an internal combustion engine capable of satisfactorily suppressing noise and vibration of a fuel pump according to a temperature of fuel.

In order to achieve this object, the invention according to a first aspect is a fuel pressure control device for an internal combustion engine which controls a fuel pressure PF which is a pressure of fuel which is supplied to a fuel injection valve 10 by a pressure applied from a fuel pump (a high-pressure pump 16 in an embodiment (hereinafter, the same is applied in this paragraph)) in an internal combustion engine 3. The fuel pressure control device includes: a map storage unit (ECU 2) which stores a first map (FIG. 4A) for defining a first target fuel pressure PFCMD1 for normal time and a second map (FIG. 5A) for defining a second target fuel pressure PFCMD2 for suppressing noise and vibration which is smaller than the first target fuel pressure PFCMD1; a fuel temperature acquisition unit (ethanol concentration sensor 41) which acquires a fuel temperature TF; a target fuel pressure setting unit (ECU 2, steps 1 to 3 and 5 and 6 of FIG. 3) which sets the first target fuel pressure PFCMD1 defined in the first map as a target fuel pressure PFCMD when the acquired fuel temperature TF is higher than a predetermined temperature TREF and sets the second target fuel pressure PFCMD2 defined in the second map as the target fuel pressure PFCMD when the fuel temperature TF is equal to or lower than the predetermined temperature TREF; and a fuel pressure control unit (ECU 2, step 7) which controls the fuel pressure PF on a basis of the set target fuel pressure PFCMD.

In the fuel pressure control device for the internal combustion engine, the fuel pressure which is the pressure of the fuel which is supplied to the fuel injection valve by the pressure applied from the fuel pump is controlled. In this fuel pressure control device, a first map for defining the first target fuel pressure for normal time and a second map for defining the second target fuel pressure for suppressing noise and vibration smaller than the first target fuel pressure are stored. Further, when the acquired fuel temperature is higher than the predetermined temperature, the first target fuel pressure defined in the first map is set as the target fuel pressure, and when the fuel temperature is equal to or lower than the predetermined temperature, the second target fuel pressure defined in the second map is set as the target fuel pressure. Further, the fuel pressure is controlled on the basis of the target fuel pressure set as described above.

As described above, it is confirmed that particularly in a case where the fuel pressure is high, the noise and vibration characteristics of the fuel pump vary depending on the fuel temperature, and the vibration and noise of the fuel pump increases as the fuel temperature decreases. According to the present invention, as described above, when the acquired fuel temperature is higher than the predetermined temperature, the first target fuel pressure for normal time is set as the target fuel pressure, and when the fuel temperature is equal to or lower than the predetermined temperature, the second target fuel pressure for suppressing noise and vibration smaller than the first target fuel pressure is set as the target fuel pressure. Accordingly, when the noise and vibration of the fuel pump may increase due to a low fuel temperature, the noise and vibration of the fuel pump can be satisfactorily suppressed by lowering the fuel pressure by the fuel pump.

The invention according to a second aspect is the fuel pressure control device for the internal combustion engine according to the first aspect. The fuel pressure control device further includes: an ethanol concentration detection unit (ethanol concentration sensor 41) which detects an ethanol concentration CE of fuel. The target fuel pressure setting unit sets the second target fuel pressure PFCMD2 as the target fuel pressure PFCMD when the fuel temperature TF is equal to or lower than the predetermined temperature TREF, and the detected ethanol concentration CE is equal to or greater than a predetermined concentration CREF (steps 1 to 6).

In a case where the fuel contains ethanol, the noise and vibration characteristics of the fuel pump vary depending not only on the fuel temperature but also on the ethanol concentration of the fuel, and the vibration and noise of the fuel pump increases as the ethanol concentration increases. According to the present invention, as described above, when the acquired fuel temperature is equal to or lower than the predetermined temperature, and the detected ethanol concentration is equal to or greater than the predetermined concentration, the second target fuel pressure PFCMD2 is set as the target fuel pressure PFCMD. Accordingly, when the noise and vibration of the fuel pump may increase due to a low fuel temperature and a high ethanol concentration, the noise and vibration of the fuel pump can be more satisfactorily suppressed by lowering the fuel pressure by the fuel pump.

The invention according to a third aspect is the fuel pressure control device for the internal combustion engine according to the first or second aspect. The first and second target fuel pressures PFCMD1 and PFCMD2 are respectively set in the first and second maps in accordance with a rotational speed NE and a load (load factor rl_w) of the internal combustion engine 3, and when the internal combustion engine 3 is in a predetermined low-medium rotational speed area (fuel pressure reduction area of FIG. 5A), the second target fuel pressure PFCMD2 is set to a value smaller than the first target fuel pressure PFCMD1 under a condition that the rotational speed NE and the load of the internal combustion engine 3 are the same.

In a case where the rotational speed of the internal combustion engine is high, the noise and vibration of the internal combustion engine are relatively large, and thus the noise and vibration of the fuel pump are hardly noticeable. On the other hand, when the rotational speed of the internal combustion engine is low, the noise and vibration of the internal combustion engine are relatively small, and thus the noise and vibration of the fuel pump are noticeable and are easily noticed by the user. According to the present invention, as described above, the second target fuel pressure is set to a value smaller than the first target fuel pressure only in a situation where the internal combustion engine is in a predetermined low-medium rotational speed area, and thus the noise and vibration of the fuel pump are noticeable. Therefore, the noise and vibration of the fuel pump can be effectively suppressed in accordance with the rotational speed of the internal combustion engine.

The invention according to a fourth aspect is the fuel pressure control device for the internal combustion engine according to the third aspect. When the internal combustion engine 3 is in the predetermined low-medium rotational speed area and in a predetermined low-medium load area, the second target fuel pressure PFCMD2 is set to a value smaller than the first target fuel pressure PFCMD1 (fuel pressure reduction area of FIG. 5A) under the condition that the rotational speed and the load of the internal combustion engine are the same.

As in the case of the rotational speed of the internal combustion engine, in a case where the load of the internal combustion engine is high, the noise and vibration of the internal combustion engine are relatively large, and thus the noise and vibration of the fuel pump are hardly noticeable. On the other hand, when the load of the internal combustion engine is low, the noise and vibration of the internal combustion engine are relatively small, and thus the noise and vibration of the fuel pump are noticeable and tend to be easily noticed by the user. According to the present invention, as described above, the second target fuel pressure is set to a value smaller than the first target fuel pressure when the internal combustion engine is in a predetermined low-medium rotational speed area and in a predetermined low-medium load area, that is, only in a situation where the noise and vibration of the fuel pump are noticeable. Therefore, the noise and vibration of the fuel pump can be more effectively suppressed in accordance with the rotational speed and the load of the internal combustion engine.

### BRIEF DESCRIPTION OF DRAWINGS

FIG. 1 is a diagram schematically illustrating an internal combustion engine, a fuel pump, and the like to which the present invention is applied;

FIG. 2 is a block diagram illustrating a fuel pressure control device;

FIG. 3 is a flowchart illustrating a fuel pressure control process;

FIG. 4A is a first map for defining a first target fuel pressure, and FIG. 4B is a diagram illustrating the first target fuel pressure for each load factor of the internal combustion engine;

FIG. 5A is a second map for defining a second target fuel pressure, and FIG. 5B is a diagram illustrating the second target fuel pressure for each load factor of the internal combustion engine; and

FIG. 6 is a diagram illustrating a reduction amount of the second target fuel pressure with respect to the first target fuel pressure for each load factor of the internal combustion engine.

### DETAILED DESCRIPTION

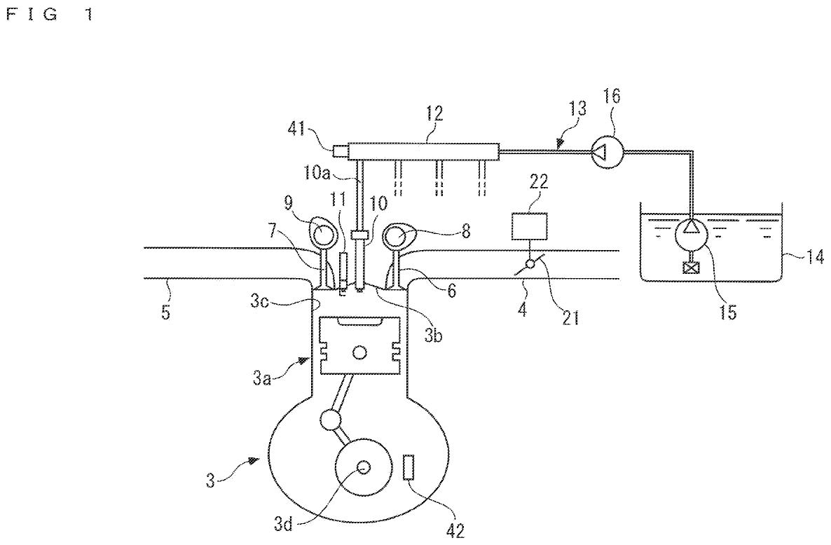

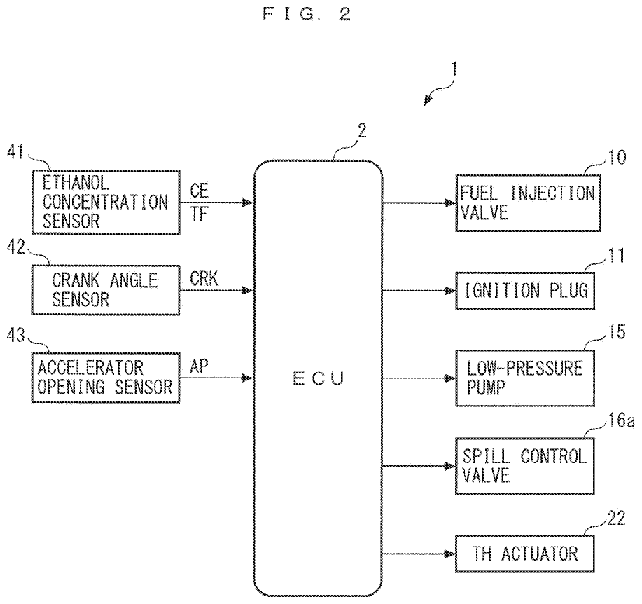

Hereinafter, a preferred embodiment of the present invention will be described in detail with reference to the drawings. As illustrated in FIGS. 1 and 2, a fuel pressure control device 1 to which the present invention is applied is provided with an ECU (electronic control unit) 2 and executes various control processes including fuel pressure control of an internal combustion engine (hereinafter referred to as an “engine”) 3.

For example, the engine 3 is mounted on a vehicle (not illustrated) as a power source and can use not only gasoline but also fuel obtained by mixing gasoline and ethanol. The engine 3 has a plurality of cylinders 3a (only one illustrated). An intake pipe 4 and an exhaust pipe 5 are connected to each cylinder 3a, and an intake valve 6 and an exhaust valve 7 provided in the intake port and the exhaust port are driven by an intake camshaft 8 and an exhaust camshaft 9, respectively.

In a cylinder head 3b of each cylinder 3a, a fuel injection valve (hereinafter referred to as “injector”) 10 is attached at the center, and an ignition plug 11 is attached adjacent thereto to face a combustion chamber 3c. That is, the engine 3 is a direct injection type in which fuel is directly injected from the injector 10 into the combustion chamber 3c of the cylinder 3a. The opening/closing operation of the injector 10 and the ignition timing of the ignition plug 11 are controlled by the ECU 2.

Each injector 10 is connected via a fuel supply short pipe 10a, a delivery pipe 12, and a fuel supply pipe 13 to a fuel tank 14. A low-pressure pump 15 is provided at the most upstream position of the fuel supply pipe 13, and a high-pressure pump 16 is provided at the middle of the fuel supply pipe 13.

The low-pressure pump 15 is an electric pump. Under the control of the ECU 2, the low-pressure pump pressurizes fuel in the fuel tank 14 at a predetermined low pressure and then discharges the fuel through the fuel supply pipe 13 to the high-pressure pump 16.

The high-pressure pump 16 is a mechanical type pump which is driven by, for example, a pump drive cam (not illustrated) provided integrally with the intake camshaft 8. The high-pressure pump pressurizes the fuel from the low-pressure pump 15 at a higher pressure and discharges the fuel through the fuel supply pipe 13 toward the delivery pipe 12. The high-pressure fuel stored in the delivery pipe 12 is supplied through the fuel supply short pipe 10a to the injector 10 and is injected into the combustion chamber 3c by opening the valve of the injector 10.

The high-pressure pump 16 includes a spill control valve 16a (see FIG. 2). The spill control valve 16a is configured by a solenoid valve and controls a spill operation for circulating the fuel sucked into the high-pressure pump 16 to the low-pressure side. More specifically, when the valve closing timing of the spill control valve 16a is controlled by the ECU 2, the spill amount of fuel is adjusted, and thereby the discharge amount of fuel to the delivery pipe 12 and a pressure (hereinafter referred to as “fuel pressure”) PF of the fuel in the delivery pipe 12 are controlled.

The delivery pipe 12 is provided with an ethanol concentration sensor 41 for detecting an ethanol concentration CE of fuel. The ethanol concentration sensor 41 incorporates a thermistor (not illustrated) for detecting a temperature TF of fuel and outputs a detection signal representing the ethanol concentration CE and the fuel temperature TF to the ECU 2.

The intake pipe 4 is provided with a throttle valve 21. The opening of the throttle valve 21 is controlled via a TH actuator 22 by the ECU 2, thereby controlling the amount of the intake air suck into the combustion chamber 3c.

A crankshaft 3d of the engine 3 is provided with a crank angle sensor 42. The crank angle sensor 42 outputs a CRK signal, which is a pulse signal, to the ECU 2 at every predetermined crank angle (for example, 30°) in accordance with the rotation of the crankshaft 3d. The ECU 2 calculates a rotational speed (hereinafter, referred to as “engine speed”) NE of the engine 3 on the basis of the CRK signal.

As illustrated in FIG. 2, a detection signal representing an accelerator opening AP which is an operation amount of an accelerator pedal (not illustrated) of the vehicle is input from an accelerator opening sensor 43 to the ECU 2. The ECU 2 calculates the load factor rl_w of the engine 3 to be substantially proportional to the accelerator opening AP on the basis of the accelerator opening AP or the like.

The ECU 2 is configured by a microcomputer including a CPU, a RAM, a ROM, and an I/O interface (all not illustrated). In response to the detection signals of the above-described sensors 41 to 43 or the like, the ECU 2 executes various kinds of engine control such as the fuel injection control by the injector 10, the ignition timing control by the ignition plug 11, and the intake air amount control by the throttle valve 21 according to the control program stored in the ROM or the like.

In this embodiment, particularly, the ECU 2 executes fuel pressure control of controlling the fuel pressure PF in order to suppress the noise and vibration of the high-pressure pump 16. In this embodiment, the ECU 2 corresponds to a map storage unit, a target fuel pressure setting unit, and a fuel pressure control unit.

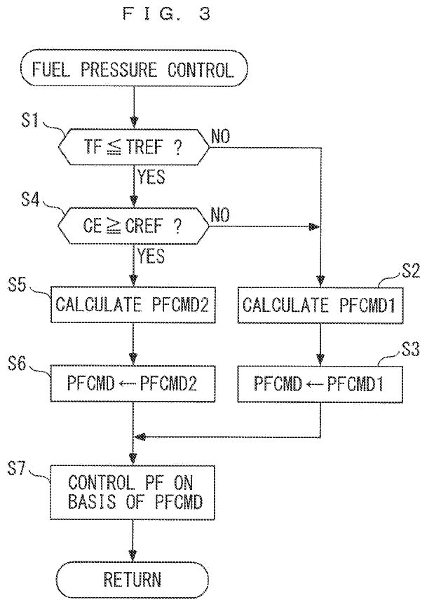

FIG. 3 illustrates the fuel pressure control process. This process is repeatedly executed every predetermined time. In this process, first, in step 1 (illustrated as “S1”, and hereinafter, the same is applied), it is determined whether or not the detected fuel temperature TF is equal to or lower than a predetermined temperature TREF. The predetermined temperature TREF is set to a lower limit value, such as +5° C., of the fuel temperature TF such that the noise and vibration of the high-pressure pump 16 may increase when the fuel temperature TF becomes equal to or lower than the predetermined temperature TREF.

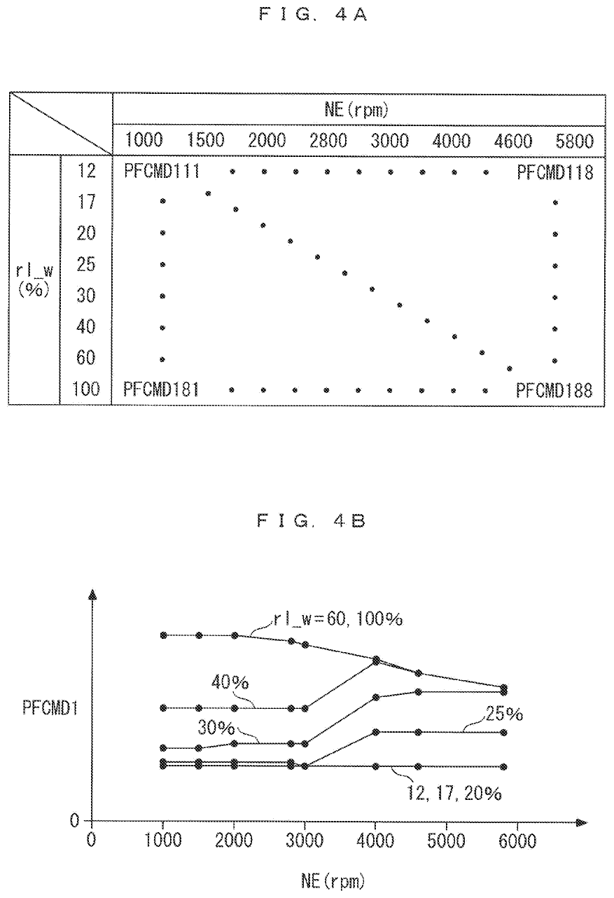

Therefore, when the answer to step 1 is NO, and the fuel temperature TF is higher than the predetermined temperature TREF, it is considered that the noise and vibration of the high-pressure pump 16 are not likely to increase, and the process proceeds to steps 2 and 3. In step 2, a first target fuel pressure PFCMD1 is calculated by searching a first map illustrated in FIG. 4A in accordance with the detected engine speed NE and the load factor rl_w, and in step 3, the calculated first target fuel pressure PFCMD1 is set as a target fuel pressure PFCMD.

In the first map, as a target fuel pressure for normal time in which the noise and vibration of the high-pressure pump 16 are not likely to increase, the first target fuel pressures PFCMD1 are obtained in advance for combinations of a plurality (in this example, eight for each) of engine speeds NE and load factors rl_w and are mapped. Further, FIG. 4B illustrates the first target fuel pressure PFCMD1 of FIG. 4A as a line graph for each load factor rl_w. As illustrated in this drawing, the first target fuel pressure PFCMD1 is basically set to a larger value when the load factor rl_w increases.

When the answer to step 1 is YES, the process proceeds to step 4, and it is determined whether the detected ethanol concentration CE is equal to or higher than a predetermined concentration CREF. The predetermined concentration CREF is set to an upper limit value, for example, 85%, of the ethanol concentration CE such that the noise and vibration of the high-pressure pump 16 may increase when the ethanol concentration CE becomes higher than the predetermined concentration CREF.

Therefore, when the answer to step 4 is NO, and the ethanol concentration CE is lower than the predetermined concentration CREF, it is considered that the noise and vibration of the high-pressure pump 16 are not likely to increase, and the process proceeds to steps 2 and 3. Then, the first map is searched, and the first target fuel pressure PFCMD1 is calculated and set as the target fuel pressure PFCMD.

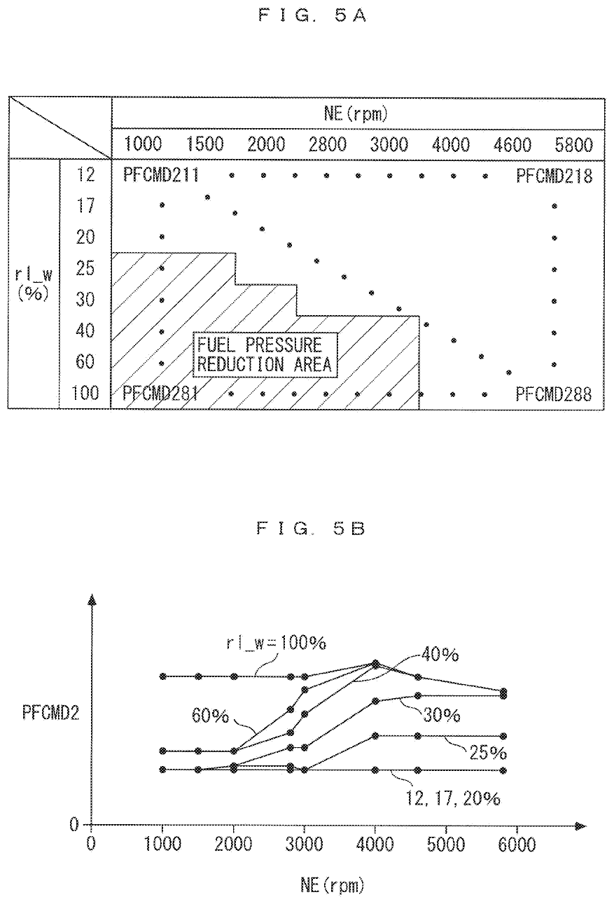

On the other hand, when the answer to step 4 is YES, that is, when the fuel temperature TF is equal to or lower than the predetermined temperature TREF, and the ethanol concentration CE is equal to or higher than the predetermined concentration CREF, it is considered that the noise and vibration of the high-pressure pump 16 may increase, and the process proceeds to steps 5 and 6. In step 5, a second target fuel pressure PFCMD2 is calculated by searching a second map illustrated in FIG. 5A in accordance with the engine speed NE and the load factor rl_w, and in step 6, the calculated second target fuel pressure PFCMD2 is set as a target fuel pressure PFCMD.

In the second map, the second target fuel pressure PFCMD2 for suppressing the noise and vibration of the high-pressure pump 16 is obtained in advance for combinations of a plurality of engine speeds NE and load factors rl_w which are the same as in the case of the first map and are mapped. The second target fuel pressure PFCMD2 is set to a value smaller than the first target fuel pressure PFCMD1 in a predetermined fuel pressure reduction area (an area of low-medium rotation and low-medium load) indicated by hatching in FIG. 5A, and is set to the same value as the first target fuel pressure PFCMD1 in other operation areas.

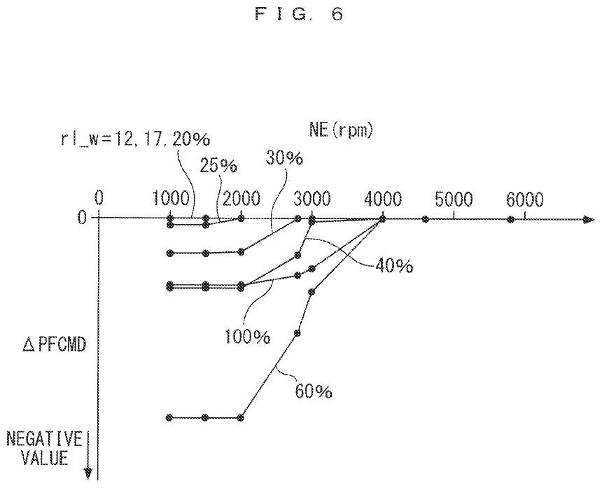

As illustrated in FIG. 6, a difference ΔPFCMD (PFCMD2−PFCMD1) between both target fuel pressures, that is, the reduction amount of the second target fuel pressure PFCMD2 relative to the first target fuel pressure PFCMD1 is largest when the load factor rl_w=60%, and next becomes large when rl_w=100% or 40%.

Returning to FIG. 3, in step 7, on the basis of the target fuel pressure PFCMD set in step 3 or 6, the high-pressure pump 16 is controlled to control the fuel pressure PF to the target fuel pressure PFCMD, and the process ends.

As described above, according to this embodiment, when the detected fuel temperature TF is higher than the predetermined temperature TREF, or the detected ethanol concentration CE is lower than the predetermined concentration CREF, the first map illustrated in FIG. 4A is selected, and the first target fuel pressure PFCMD1 for normal time is calculated according to the engine speed NE and the load factor rl_w and is set as the target fuel pressure PFCMD. Accordingly, when the noise and vibration of the high-pressure pump 16 are not likely to increase, the fuel pressure PF can be appropriately controlled according to the engine speed NE and the load factor rl_w.

On the other hand, when the fuel temperature TF is equal to or lower than the predetermined temperature TREF, and the ethanol concentration CE is equal to or greater than the predetermined concentration CREF, the second map illustrated in FIG. 5A is selected, and the second target fuel pressure PFCMD2 for suppressing the noise and vibration smaller than the first target fuel pressure PFCMD1 is calculated according to the engine speed NE and the load factor rl_w and is set as the target fuel pressure PFCMD. Accordingly, when the noise and vibration of the high-pressure pump 16 may increase, the noise and vibration of the high-pressure pump 16 can be satisfactorily suppressed by reducing the fuel pressure PF.

In the second map, as shown as a fuel pressure reduction area, when the engine 3 is in a predetermined low-medium rotational speed area and in a predetermined low-medium load area, that is, only in a situation where the noise and vibration of the high-pressure pump 16 are noticeable, the second target fuel pressure PFCMD2 is set to a value smaller than the first target fuel pressure PFCMD1. Accordingly, the noise and vibration of the fuel pump can be effectively suppressed according to the rotational speed and load of the engine 3.

Incidentally, the present invention is not limited to the embodiment described above but may be practiced in various aspects. For example, in the embodiment, the ethanol concentration CE is used in addition to the fuel temperature TF as a parameter for determining whether to select the first map (first target fuel pressure PFCMD1) or the second map (second target fuel pressure PFCMD2). The invention is not limited thereto, and other suitable parameters may be used with or instead of the ethanol concentration CE.

In the embodiment, the fuel temperature TF is detected by using the ethanol concentration sensor 41. However, the fuel temperature may be detected by a dedicated temperature sensor or may be obtained by estimation from other suitable operating parameters such as an engine water temperature, an intake air temperature, a total amount of fuel injection from the start, and the like. Further, the load factor rl_w based on the accelerator opening AP is used as a parameter representing the load of the engine 3. However, other suitable parameters such as an accelerator opening AP itself, a fuel injection amount, an intake air amount, and the like may be used.

In the embodiment, the control of the fuel pressure PF based on the set target fuel pressure PFCMD is performed by feedforward control. However, the control may be performed by feedback control such that the fuel pressure PF is detected, and the detected fuel pressure PF becomes the target fuel pressure PFCMD.

In the embodiment, the fuel pump is a high-pressure pump with a spill control valve. However, the fuel pump may be other types, and the configuration thereof is arbitrary. Further, the specific numerical values and the numerical values indicating the predetermined temperature TREF and the predetermined concentration CREF described in the embodiment are merely examples, and it is needless to say that other suitable numerical values may be adopted. In addition, the configuration of the details can be appropriately changed within the scope of the present invention.

What is claimed is:

1. A fuel pressure control device for an internal combustion engine which controls a fuel pressure which is a pressure of fuel which is supplied to a fuel injection valve by a pressure applied by a fuel pump in the internal combustion engine, the device comprising:
a map storage unit which stores a first map for defining a first target fuel pressure for normal time and a second map for defining a second target fuel pressure for suppressing noise and vibration which is smaller than the first target fuel pressure;
a fuel temperature acquisition unit which acquires a fuel temperature;
a target fuel pressure setting unit which sets the first target fuel pressure defined in the first map as a target fuel pressure when the acquired fuel temperature is higher than a predetermined temperature and sets the second target fuel pressure defined in the second map as the target fuel pressure when the fuel temperature is equal to or lower than the predetermined temperature; and
a fuel pressure control unit which controls the fuel pressure on a basis of the set target fuel pressure.

2. The fuel pressure control device for the internal combustion engine according to claim 1, the device further comprising:
an ethanol concentration detection unit which detects an ethanol concentration of fuel, wherein
the target fuel pressure setting unit sets the second target fuel pressure as the target fuel pressure when the fuel temperature is equal to or lower than the predetermined temperature, and the detected ethanol concentration is equal to or greater than a predetermined concentration.

3. The fuel pressure control device for the internal combustion engine according to claim 1, wherein the first and second target fuel pressures are respectively set in the first and second maps in accordance with a rotational speed and a load of the internal combustion engine, and when the internal combustion engine is in a predetermined low-medium rotational speed area, the second target fuel pressure is set to a value smaller than the first target fuel pressure under a condition that the rotational speed and the load of the internal combustion engine are the same.

4. The fuel pressure control device for the internal combustion engine according to claim 3, wherein when the internal combustion engine is in the predetermined low-medium rotational speed area and in a predetermined low-medium load area, the second target fuel pressure is set to a value smaller than the first target fuel pressure under the condition that the rotational speed and the load of the internal combustion engine are the same.
